(19) United States
(12) Patent Application Publication
(10) Pub. No.: US 2006/0172120 A1
(43) Pub. Date: Aug. 3, 2006

(54) SYSTEM AND METHOD FOR MANUFACTURING AN ORIGINAL WORK OF ART

(76) Inventors: Lawrence J. Longobardi, Olivenhain, CA (US); Jeffrey Ditoro, San Diego, CA (US)

Correspondence Address: NYDEGGER & ASSOCIATES, 348 OLIVE STREET, SAN DIEGO, CA, 92103, US

(21) Appl. No.: 11/279,818

(22) Filed: Apr. 14, 2006

Related U.S. Application Data
(63) Continuation-in-part of application No. 10/459,269, filed on Jun. 11, 2003.

(51) Int. Cl. B32B 3/00

(52) U.S. Cl. 428/156

(57) ABSTRACT

An original work of art, and its method of manufacture, requires a substrate on which layers of viscous ink are sequentially applied to create a plurality of visual contrasts. Each contrast may have its own predetermined number of ink layers. A color print layer is then applied over the contrasts to create the work of art. Importantly, each layer of viscous ink is individually applied, and is individually cured with UV radiation, before a subsequent layer is applied. In this process, each layer may contribute to one or more contrasts. The color print layer is then applied using a computerized color printer.

This application is a continuation-in-part of application Ser. No. 10/459,269, filed Jun. 11, 2003, which is currently pending. The contents of application Ser. No. 10/459,269 are incorporated herein by reference.

### FIELD OF THE INVENTION

The present invention pertains generally to devices and implements for creating original works of fine art using computerized techniques. More particularly, the present invention pertains to visual works of art having physical enhancements for the presentation of shading depth and definition. The present invention is particularly, but not exclusively useful for creating original works of art using ultraviolet (UV) curable inks and a computerized color printer.

### BACKGROUND OF THE INVENTION

All works of art involve the making or doing of things that display form, beauty, and an unusual or unique perception. In the case of fine art, the characteristics of the work are distinguished by their purely aesthetic value. More particularly, insofar as fine art paintings are concerned, the aesthetic value of a particular work is found not only in its presentation, but also in the contrasts that are introduced into the work by the artist. These contrasts can be either textural or tonal in nature, and will include the shadings, depth and definition that make the artwork extraordinary and unique.

Reproductions of an original artwork, like the original itself, can also be valuable. The value of a reproduction, however, depends in large part on how faithful the reproduction is in its presentation of the original. For instance, in the reproduction of an oil painting, the ability to accurately incorporate the contrasts that were made by the artist in the original, may greatly enhance the value of the reproduction. Depending on the particular work of art, these contrasts can be many and varied, and will include such nuances as brush strokes and color variations. It is almost needless to say that the contrasts which add so much to a work of fine art are often subtle and, accordingly, quite difficult to reproduce.

Various devices and techniques have been developed over recent years for the reproduction of visual works. Of particular interest here are the so-called color printers that can accurately reproduce the colors of an original subject. In general, color printing is achieved by any of several printing processes wherein each color is printed separately, in a predetermined order. The superimposed impression, when accurately registered, then builds up an image that corresponds in color to the original subject. Recently, color print processes have been greatly improved by incorporating computer control over the printing process.

Though very effective, color print processes are somewhat limited by the physical characteristics of the inks that are used in the process. Of particular importance in this regard is the viscosity, or resistance to flow, of the inks that are used. Typically, for operational reasons, the inks that are used in color print processes have rather low viscosities, i.e. they are thin and flow easily. Thus, although the colors in an original work of art may be accurately reproduced using a color print process, the result is an essentially two-dimensional presentation. Consequently, a color print process, alone, will not produce the three-dimensional contrasts that are of crucial importance for the accurate presentation of a work of fine art.

It is known that inks having viscosities which are much greater than the viscosities required for use in a color print process can be used to provide three-dimensional effects for a reproduced work of art. Specifically, it is known that extremely viscous inks (i.e. so-called “thick” inks) can be effectively incorporated into a reproduced work of art by using screen printing processes. For example, U.S. Pat. No. 4,933,218, which issued to Longobardi for an invention entitled “Sign with Transparent Substrate” discloses the use of screen printing to achieve a three-dimensional effect in an artwork by incorporating an “extremely thick ridge of ink” into the artwork. Ridges alone, however, do not recreate the textural and tonal contrasts found in a work of fine art. Consequently, it may be desirable to conform the viscous ink to a variety of shapes, sizes or configurations. In some instances, however, it may happen that due to an extensive vertical dimension, the variations may deform before the final product can be produced.

In light of the above, it is an object of the present invention to provide a reproduction of an original work of art, and a method for manufacturing the same, which includes the textural and tonal contrasts that are presented in the original work of art. Another object of the present invention is to provide a reproduction of an original work of art, and a method for manufacturing the same, wherein a screen printing process and a color printing process are used together, in combination, to recreate the contrasts that are found in a work of fine art, and to incorporate these contrasts into a reproduction of the original. Yet another object of the present invention is to provide an original work of art, and a method for manufacturing same, wherein the finalized work of art includes the characteristics and depth of contrasts normally found only in the brush strokes of oil paintings. Yet another object of the present invention is to provide a reproduction of an original work of art, and a method for manufacturing the same, which includes the use of inks that can be presented in a variety of shapes, sizes or configurations and maintained without premature deformation before the final product has been produced. Still another object of the present invention is to provide a reproduction of an original work of art, and a method for manufacturing the same, which is easy to implement and comparatively cost effective.

### SUMMARY OF THE INVENTION

In accordance with the present invention a method for creating a reproduction of an original work of art is disclosed wherein the textural and tonal contrasts created by the artist in the original artwork are presented in the reproduction. In overview, the methods and products that are disclosed for the present invention involve the creation and combination of various layers of materials. Importantly, the combination of these various layers subsequently serve as the foundation for a color print process.

For the present invention, a base substrate is provided that has a substantially flat surface. The surface may be either reflective or non-reflective, and it may be of any desired color. Also, the base substrate may be made of paper stock or it may be made of a reflective material, such as aluminum sheeting. Further, if made of paper stock, the base substrate may be coated, or uncoated, or covered with a metallic foil.

A key aspect of the present invention is that a relief layer is applied to the surface of the substrate. Importantly, this relief layer has ink deposits that are dimensioned and arranged to correspond with the contrasts that were created by the artist in the original work of art. Preferably, the relief layer will include a clear plastic sheet on which the ink deposits have been placed. This clear plastic sheet, along with the ink deposits, can then be bonded directly onto the surface of the base substrate. Alternatively, the clear plastic sheet need not be used and, instead, the ink deposits can be placed directly onto the base substrate. In either case, the ink deposits of the relief layer are created by a screen printing process using a thick, extremely viscous ink. In cases where the art presentation requires significant three dimensional variations in the ink work, it may be desirable to use a viscous, ultraviolet (UV) curable ink. If used, after it has been formed on the relief layer, the UV curable ink may be “set-up” by exposure to ultraviolet radiation before proceeding with subsequent steps in the manufacture of the final product.

After being screen printed, but before UV curing, the viscous ink deposits of the relief layer can be further refined by manually using other tools, such as a brush or spatula. The purpose in using these various tools is to refine the contrasts that are being incorporated into the reproduction. For example, in the specific case of an oil painting, the contrasts may be refined to give an impression of brush strokes in the reproduction. Further, in order to give the reproduction additional texture, depth and definition, the relief layer can be made by selectively using clear or color tinted inks for the viscous UV curable ink deposits.

Whenever the surface of the base substrate is reflective in nature, an optional white layer can be used for the present invention. If used, this white layer will be positioned between the reflective surface of the substrate and the relief layer to provide an opacity that will diminish the reflectivity of selected portions of the reflective surface. Like the relief layer, this white layer is preferably created by a screen printing process. Also, like the relief layer, the white layer may include a clear substrate which can then be bonded to the surface of the base substrate. If a white layer is used, the relief layer would be applied onto the white layer.

Once the various layers have been combined as indicated above, a color print layer is positioned over the relief layer to provide the reproduction with a color replication of the work of art being reproduced. Preferably, for all embodiments of the present invention, the relief layer is located between the surface of the substrate and the color print layer. In this combination, the ink deposits of the relief layer are incorporated into the color replication of the color print layer as contrasts from the original work of art.

As envisioned for the present invention, the positioning of the color print layer can be computerized. Specifically, the color print layer will include a plurality of variously colored ink dots that are deposited onto the relief layer according to the instructions of a computer program. The computer program is also employed to register the color print layer with the relief layer.

In a preferred embodiment of the present invention, the relief layer actually includes a plurality of layers of viscous ink that are each individually applied to the surface of a substrate. Specifically, this is done in a predetermined manner to create what is hereinafter referred to as “contrasts” for the work of art. Importantly, for this aspect of the present invention, the viscous ink that is used is one of the so-called “thick” inks, and it is preferably curable by ultraviolet radiation (i.e. a UV curable ink).

For the manufacture of the work of art, a layer of the UV curable viscous ink is screen printed onto selected portions of the surface of the substrate. This first layer is the base layer. Immediately after it has been applied, the base layer is cured with ultraviolet radiation. Next, a new layer of UV curable viscous ink is added onto the base layer. The new layer is then immediately cured by ultraviolet radiation. Like the base layer, the new layer can be screen printed. Thereafter, additional new layers can then be added as desired. In each case, however, it is important that the new layer is immediately cured by ultraviolet radiation after it has been applied. The result of this is a build-up of individual layers that will create a plurality of textural contrasts for the work of art. More specifically, each textural contrast will include at least one layer of viscous ink, and at least one of the contrasts will include a plurality of layers of viscous ink.

Collectively, the ink layers that combine to create the textural contrasts will function structurally in a manner similar to the relief layer disclosed above in comparison with a single layer, however, the textural contrasts of the present invention can be made to extend significantly above the surface of the substrate. Specifically, this is possible by the sequential application and curing of each layer of viscous ink before a subsequent layer of ink is applied and cured. The consequent build-up of ink layers in each contrast thereby provides a three-dimensional feature of depth for the work of art that is not otherwise obtainable.

As indicated above, once the textural contrasts have been manufactured, a computerized color printer can be used to apply a color print layer over them. This incorporates the contrasts into the color print layer for a combined presentation in the work of art. Additional considerations for the present invention include the use of a reflective substrate surface, and the application of a white ink layer on selected portions of the reflective surface to provide a contrasting opacity. Also, if desired, the viscous inks can be colored, rather than clear. Further, the white ink layer, the contrasts and the color print layer can all be applied to a clear plastic sheet and bonded to the substrate as disclosed above.

In addition to making reproductions of other works of art, the methods and processes of the present invention are also applicable for the creation of original works of art. To do this, the artist prepares a computer program for the color print layer according to his/her desires. This computer program is then used to control a color printer for the generation of the color print layer. The relief layer is also prepared by the artist according to his/her desires and, in a first step, is placed or applied to the substrate by a silk screening process. The silk screening can then be enhanced by whatever further refinements may be wanted by the artist. As mentioned above, refinements to the relief layer can be manually introduced by the artist. Specifically is can be done using tools, such as a brush or spatula. If UV curable ink is used, the relief layer can then be set by exposure to ultraviolet radiation. Similarly, an optional white layer can be prepared by the artist and incorporated in the manner discussed above. The substrate with its relief layer and white layer (optional) can then be run through the color printer to create the original work of art.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an elevational view of a reproduction of a work of fine art in accordance with the present invention;

FIG. 2 is a cross sectional view of the reproduction as seen along the line 2-2 in FIG. 1;

FIG. 3 is an exploded perspective view of the fine art reproduction according to the present invention, showing various layers of the reproduction positioned for combined incorporation;

FIG. 4 is a schematic representation of a method for manufacturing a fine art reproduction in accordance with the present invention;

FIG. 5A is a cross sectional view of a preferred embodiment of the present invention as seen along the line 2-2 in FIG. 1; and

FIG. 5B is a cross sectional view of an optional embodiment of the present invention shown in FIG. 5A.

### DESCRIPTION OF THE PREFERRED EMBODIMENTS

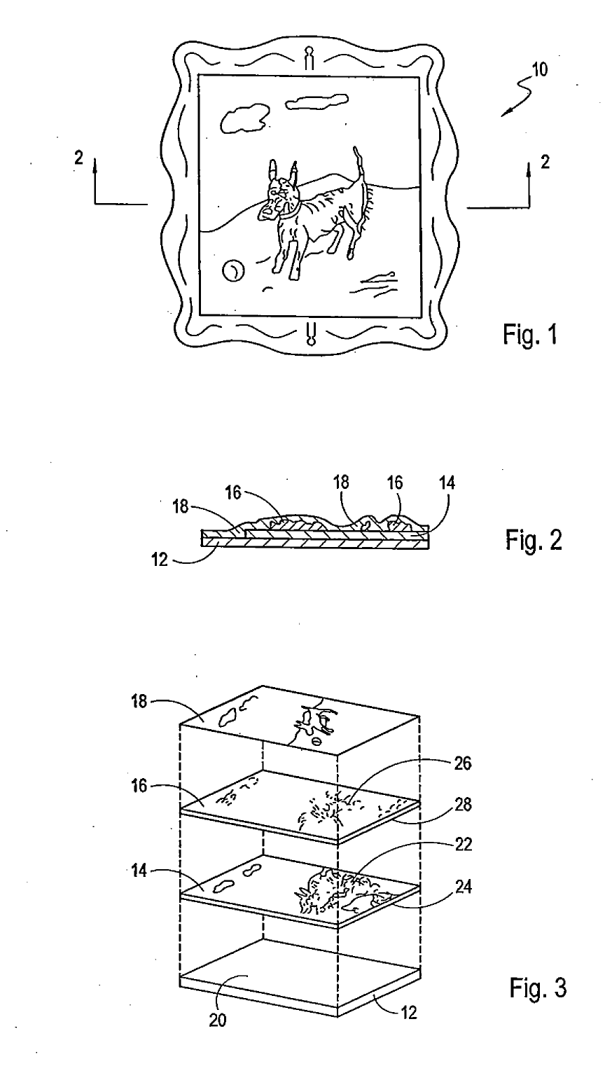

Referring initially to FIG. 1, a reproduction of fine art that has been manufactured in accordance with the present invention is shown and is generally designated 10. More particularly, the construction of the reproduction 10 will be best appreciated with reference to FIG. 2. There it will be seen that the reproduction 10 essentially includes a base substrate 12 on which a white layer 14 has been deposited. Additionally, there is a relief layer 16 and a color print layer 18 which overlies the base substrate 12 to place both the white layer 14 and the relief layer 16 between the base substrate 12 and the color print layer 18. The actual construction of the reproduction 10 will, perhaps, be best appreciated by cross referencing FIG. 2 with FIG. 3, and by individually considering each portion of the construction.

For purposes of the present invention, the base substrate 12 may be made of paper stock, metal sheeting (e.g. aluminum), or any other type of suitable material known in the pertinent art. Regardless of the material used for base substrate 12, and although the base substrate 12 may be shaped as desired (the rectangular shape shown in FIG. 3 is only exemplary), the base substrate 12 will preferably have a substantially flat surface 20. As envisioned for the present invention, the surface 20 may be either reflective or non-reflective.

In the event that the surface 20 of base substrate 12 is reflective in nature, the reproduction 10 may include the white layer 14. Use of the white layer 14, however, is optional. If used, the white layer 14 will include a white opaque ink 22 that may be selectively placed on a clear plastic sheet 24. The white layer 14 is then placed against the surface 20 of base substrate 12 with the white ink 22 covering selected portions of the surface 20. Alternatively, the white layer 14 need not include the clear sheet 24 and, instead, the white ink 22 may be applied directly to the selected portions of the surface 20. In either case, the purpose of the white ink 22 of white layer 14 is to provide an opacity that will effectively diminish the reflectivity of the selected portions of the surface 20. Recall, this white layer 14 is optional. If the surface 20 of base substrate 12 is not reflective, the white layer 14 may not be needed.

FIG. 3 shows that the relief layer 16 will include deposits of a viscous ink 26. Preferably, the ink 26 will be clear and will have a relatively high viscosity. The ink 26 may, however, be color tinted. Importantly, and regardless of color, the viscosity of ink 26 must allow the deposits of ink 26 to be configured as needed. Specifically, the deposits of ink 26 in relief layer 16 must be capable of being varied in extent, depth and orientation within the relief layer 16. The purpose here is to have the deposits of ink 26 replicate, or mimic, the textural and tonal contrasts that are found in the original artwork. Further, it will be appreciated that the deposits of ink 26 in the relief layer 16 may need to be presented in a variety of shapes, sizes or configurations. If so, in order to obviate the possible premature deformation of the deposits of ink 26, the ink 26 may be a UV curable ink, of a type well known in the pertinent art.

As also shown in FIG. 3, the deposits of ink 26 may be placed on a clear plastic sheet 28. Like the white layer 14 discussed above, however, the relief layer 16 need not include the clear sheet 28. In any event, with or without the clear sheet 28, the deposits of ink 26 in relief layer 16 are placed over the white layer 14. If the white layer 14 is not used, the relief layer 16 may be placed directly against the surface 20 of base substrate 12.

Still referring to FIG. 3, it will be appreciated that the color print layer 18 covers the other layers 14 (if used) and 16. The sole purpose of the color print layer 18 is to provide a faithful color replication of the artwork being reproduced. Preferably, the color variations of the original artwork are replicated in the color print layer 18 by a computer program that has been prepared and written in accordance with techniques that are well known in the computer art. Thus, as envisioned for the reproduction 10 of the present invention, the color print layer 18 is digitally colorized using known computer techniques.

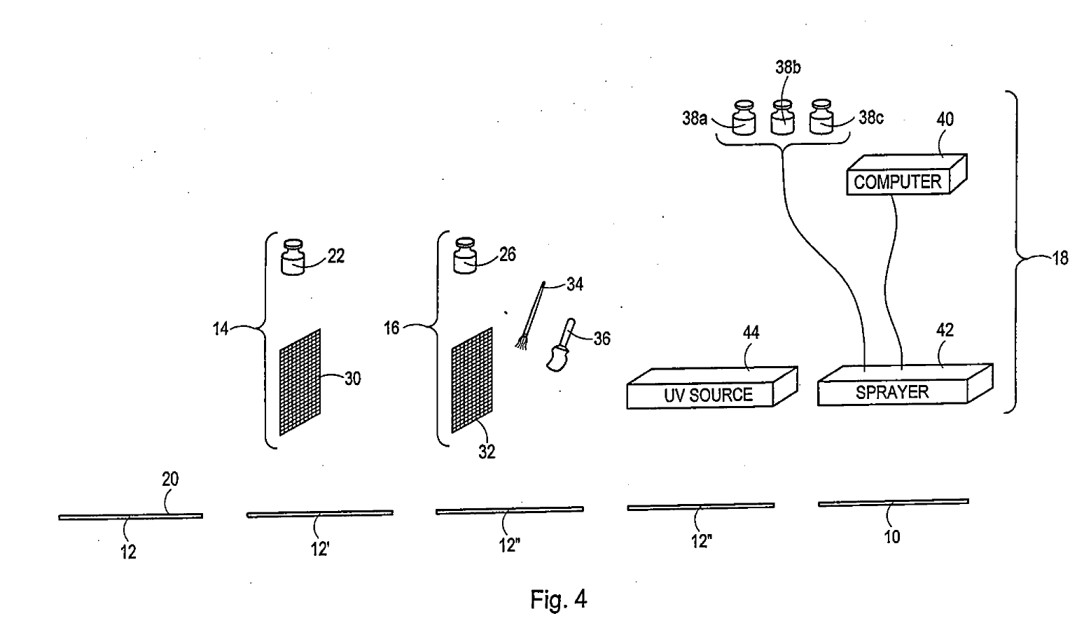

Referring now to FIG. 4, a schematic representation of a process for manufacturing a reproduction 10 in accordance with the present invention is shown. With reference to FIG. 4 it is to be appreciated that, if used, the white layer 14 is placed on the surface 20 to create a base substrate 12′. Preferably, this is done by a screen printing process wherein the white ink 22 is passed through a mask (not shown) that has been positioned on a mesh 30. As is well known in the pertinent art, this process will result in the white ink 22 being applied to only the selected portions of the surface 20 that are not covered by the mask.

Even though a white layer 14 may not be used, the relief layer 16 is applied to create a base substrate 12″. As indicated in FIG. 4, the relief layer 16 can be applied to the base substrate 12″ in a variety of ways using the viscous ink 26. Specifically, deposits of the viscous ink 26 can be applied to the base substrate 12 using a screen printing process. In FIG. 4, this screen printing process is represented by the mesh 32 which can be used with a mask (not shown) in a manner similar to that disclosed above with reference to the white layer 14. Alternatively, or in addition to the screen printing process, deposits of the viscous ink 26 can be manually applied to the base substrate 12 by using a brush 34 or a spatula 36. Regardless of the particular tool that is used in this task, it is most important that the contrasts found in the original artwork are replicated by the deposits of viscous ink 26 in the relief layer 16 for the reproduction 10. As mentioned above, these contrasts will be both tonal and textural in nature.

FIG. 4 also indicates that in the event that the viscous ink 26 is a UV curable ink, a UV source 44 can be used to radiate the base substrate 12″ with ultraviolet light. As is well known in the pertinent art, the exposure of UV curable ink to ultraviolet light will cause it to “set up” quickly, and thereby avoid a deformation of the deposit of ink 26 that might otherwise occur.

Once the relief layer 16 has been applied to the base substrate 12″, the color print layer 18 is then incorporated to create the reproduction 10. Specifically, as indicated in FIG. 4, the process of incorporating the color print layer 18 into the reproduction 10 is computerized. As with any well known color print process, the present invention envisions the use of a plurality of variously colored inks 38, of which the colored inks 38a, 38b and 38c shown in FIG. 4 are only exemplary. The individual sources of these colored inks 38, as well as a computer 40, are respectively connected to a sprayer 42. More specifically, the computer 40 is electronically connected to the sprayer 42 and, in accordance with a previously prepared computer program (not shown), the computer 40 controls the flow of the respective colored inks 38 through the sprayer 42 to create the color print layer 18. Thus, in order from front to rear, a reproduction 10 in accordance with the present invention includes, the color print layer 18, the relief layer 16, the white layer 14 (optional), and the substrate 12.

When using the techniques and methods of the present invention for the creation of an original work of art, the artist assumes total control over the creation of the various layers 14, 16 and 18. In particular, by exploiting the relatively thick viscosity of the ink 26 that is used to create the relief layer 16, the artist is able to incorporate physical enhancements for the color print layer 18 that would not be possible, otherwise. More specifically, as envisioned by the present invention, for the creation of an original work of art, the artist is free to separately and individually manipulate the white layer 14, the relief layer 16, and the color print layer 18, as desired. Moreover, by introducing variations in at least one of the other layers (e.g. the white layer 14, or the relief layer 16), while using a same color print layer 18, the artist is able to create different original works which all have a same theme or color scheme, but which all have different contrasts. More specifically, the computerized color print layer 18 can be used to establish a same theme or color scheme for different works. With a common theme or color scheme, reconfigurations of the white layer 14 and/or the relief layer 16 can be made from work to work, to create variations in extent, depth and orientation that will give each work its own original textural and tonal contrasts. As will be appreciated by the skilled artisan, the color scheme of a theme, or the theme itself, can also be changed from work to work, while the relief layer 16 or the white layer 14 (if used) remain the same. In each case, for each new work of art, the color print layer 18 is applied using a computerized color printer (i.e. computer 40 and sprayer 42).

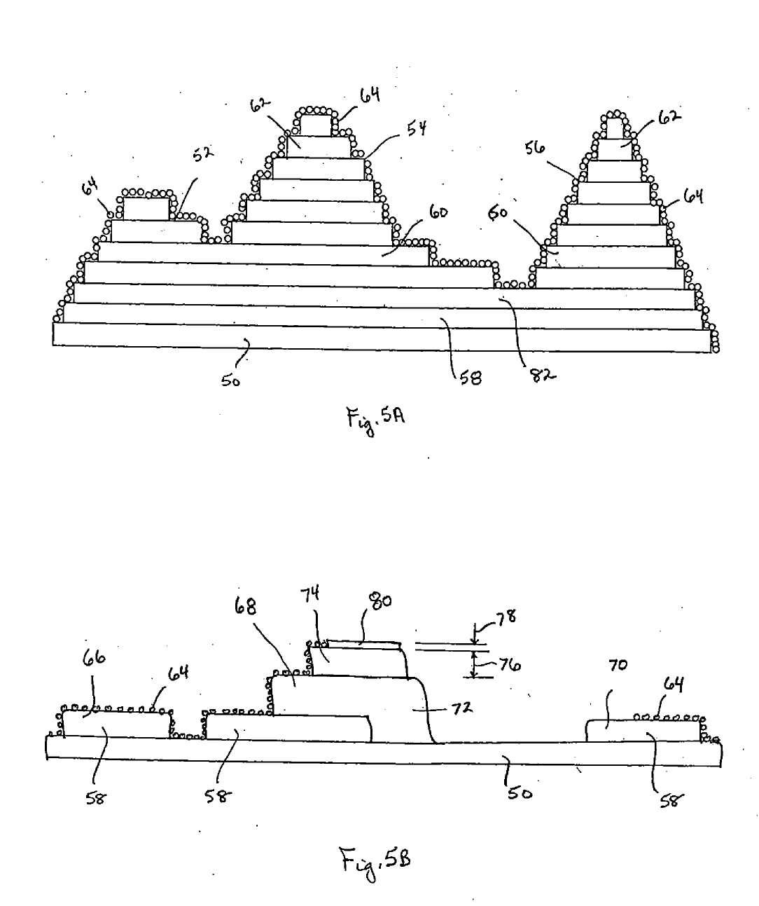

Referring now to FIGS. 5A and 5B, an important aspect of the present invention is shown wherein a substrate 50 has a plurality of contrasts that are applied to a surface of the substrate. In FIG. 5A, the contrasts 52, 54 and 56 are shown as examples for disclosure. With reference to FIG. 5A, it can be seen that a base layer 58 is first applied to the substrate 50. In accordance with above disclosure, this base layer 58 is preferably a “thick” viscous ink that can be cured by ultraviolet radiation. As envisioned for the present invention, the viscous ink that is used may be either clear or colored. Further, it is preferable that all of the various layers that comprise each contrast (e.g. contrast 54) will preferably be of a same type viscous ink.

Still referring to FIG. 5A, it can be seen that each of the contrasts 52, 54 and 56 are made of built-up layers of ink. Each layer of ink, however, may not contribute to all of the contrasts. On the other hand, a single layer of ink may contribute to more than one contrast. For example, consider the layers 60 and 62. As shown, the layer 60 contributes to each of the contrasts 52, 54 and 56. Specifically, it is contiguous in its contribution to the contrasts 52 and 54. The layer 60, however, also contributes separately to the contrast 56. Insofar as the layer 62 is concerned, although it does not contribute to the contrast 52, it contributes to both the contrast 54 and the contrast 56. As will be appreciated, several variations on the contributions of each particular ink layer is possible. In each case, once all of the contrasts have been made (e.g. contrasts 52, 54 and 56) a color print layer 64 is applied by a computerized color printer as disclosed above.

For a consideration of alternative applications for the contrasts and their respective constituent layers of ink, consider the contrasts 66, 68 and 70 that are shown in FIG. 5B. First, however, note that the base layer 58 may, itself, be discontinuously applied over the substrate 50. Also, it is possible that the color print layer 64 need not be used to cover all of the contrasts. Further, as for the contrasts themselves, it is seen that both of the contrasts 66 and 70 comprise only a single layer of ink. FIG. 5B also shows that an ink layer can cover more than only one other layer of ink. For example, in the contrast 68, a portion of the ink layer 72 covers the base layer 58, while another portion of the ink layer 72 covers the substrate 50. Further, FIG. 5B shows that the various layers of ink need not have the same thickness. Again, by way of example, the ink layer 74 of the contrast 68 is shown to have a thickness 76 that is greater than the thickness 78 of the ink layer 80.

For the manufacture of an original work of art in accordance with the present invention, the base layer 58 is first applied to the substrate 50. As shown in the FIGS. 5A and 5B, the base layer 58 need not cover the entire surface of the substrate 50. Instead, the base layer 58 can be applied to only selected portions of the surface of the substrate 50. In any event, the base layer 58 is preferably applied by screen printing. And, once it has been applied, the base layer 58 is immediately cured with ultraviolet radiation. After the base layer 58 has been UV cured, a new layer 82 (see FIG. 5A) is applied and cured. Subsequently, additional new layers of ink are applied. For each new layer, the applied ink is immediately cured with ultra violet radiation. This process then continues, with each subsequent layer of ink being applied by screen printing, and cured until all of the desired contrasts have been made. The color print layer 64 can then be applied as disclosed above.

While the particular System and Method for Manufacturing an Original Work of Art, as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A work of art which comprises:
a substrate having a surface;
a plurality of textural contrasts selectively positioned on the surface of said substrate, wherein each contrast comprises at least one layer of viscous ink, and at least one of said contrasts comprises a plurality of layers of viscous ink; and
a color print layer applied over the plurality of textural contrasts to incorporate the layers of the contrasts into the color print layer for a combined presentation thereof in the work of art.

2. A work of art as recited in claim 1 wherein the viscous ink is clear and is UV curable.

3. A work of art as recited in claim 1 wherein the surface of said substrate is reflective.

4. A work of art as recited in claim 3 further comprising a layer of white ink selectively positioned between the reflective surface of said substrate and the contrasts to provide opacity to diminish the reflectivity of selected portions of the reflective surface.

5. A work of art as recited in claim 4 wherein the contrasts and the layer of white ink are screen printed onto said substrate.

6. A work of art as recited in claim 1 wherein the color print layer is applied using a computerized color printer.

7. A work of art as recited in claim 6 wherein the color print layer comprises a plurality of variously colored ink dots.

8. A method for manufacturing a work of art which comprises the steps of:
providing a substrate having a surface;
applying a layer of viscous ink to selected portions of the surface of the substrate to create a base layer;
adding a new layer of viscous ink onto the base layer to modify the base layer;
selectively repeating said adding step to create a plurality of textural contrasts; and
covering the textural contrasts with a color print layer to incorporate the layers of the contrasts into the color print layer for a combined presentation thereof in the work of art.

9. A method as recited in claim 8 wherein the viscous ink is clear and UV curable.

10. A method as recited in claim 9 further comprising the step of curing the layers of the contrasts with ultraviolet radiation, wherein the curing step is accomplished immediately after the applying step and immediately after each adding step.

11. A method as recited in claim 8 wherein the covering step further comprises the steps of:
programming a computerized color printer with a computer program to generate the color print layer; and
using the color printer to apply the color print layer onto the contrasts.

12. A method as recited in claim 8 wherein said applying step and said adding step are accomplished by screen printing.

13. A method as recited in claim 8 wherein said applying step comprises the steps of:
screen printing the viscous ink layers of the base layer onto a clear substrate; and
bonding the clear substrate, with base layer thereon, to the surface of the base substrate.

14. A method as recited in claim 8 wherein the surface of the substrate is reflective and wherein said method further comprises the step of selectively positioning a layer of white ink between the reflective surface of said substrate and the contrasts to provide opacity to diminish the reflectivity of selected portions of the reflective surface.

15. A method for manufacturing a work of art which comprises the steps of:
providing a substrate having a surface;
applying a layer of viscous ink to selected portions of the substrate to create a base layer;
adding at least one new layer of viscous ink to selected portions of the base layer to create a plurality of textural contrasts; and
covering the textural contrasts with a color print layer to incorporate the layers of the contrasts into the color print layer for a combined presentation thereof in the work of art.

16. A method as recited in claim 15 wherein the covering step further comprises the steps of:
programming a computerized color printer with a computer program to generate the color print layer; and
using the color printer to apply the color print layer onto the contrasts.

17. A method as recited in claim 15 wherein the surface of the substrate is reflective and the viscous ink is clear and UV curable, and said method further comprises the step of curing the layers of the contrasts with ultraviolet radiation.

18. A method as recited in claim 17 wherein the curing step is accomplished immediately after the applying step and immediately after each adding step.

19. A method as recited in claim 15 further comprising the step of selectively positioning a layer of white ink between the reflective surface of said substrate and the contrasts to provide opacity to diminish the reflectivity of selected portions of the reflective surface.

20. A method as recited in claim 15 wherein said applying step and said adding step are accomplished by screen printing, and wherein the covering step further comprises the steps of:
programming a computerized color printer with a computer program to generate the color print layer; and
using the color printer to apply the color print layer onto the contrasts.
